(19) United States
(12) Patent Application Publication
(10) Pub. No.: US 2009/0109960 A1
(43) Pub. Date: Apr. 30, 2009

(54) METHOD AND APPARATUS FOR A VIRTUAL CIRCUIT DATA AREA WITHIN A PACKET DATA FRAME

(75) Inventors: Jiangnan Jason Chen, Hawthorn Woods, IL (US); Michael J. Diesen, Vernon Hills, IL (US); Yuda Y. Luz, Buffalo Grove, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/929,000

(22) Filed: Oct. 30, 2007

(51) Int. Cl. H04L 12/66

(52) U.S. Cl. 370/352

(57) ABSTRACT

A method and apparatus for a virtual circuit data area within a packet data frame is disclosed. The method may include operating (320) in a multiple connections sharing packet data frame structure with a packet oriented switching wireless access point and a related network for providing data to a wireless communication device engaged in data communications and determining (330) if a pseudo-circuit switched data area within a packet data frame format is optimal for a connection. The method may also include setting up (340) a virtual circuit data area within a packet data frame using a control configuration if a pseudo-circuit switched data area within a packet data frame format is optimal for a connection and sending (350) data in the virtual circuit data area.

### BACKGROUND

1. Field

The present disclosure is directed to a method and apparatus for a virtual circuit data area within a packet data frame. More particularly, the present disclosure is directed to providing a virtual circuit area defined in a burst area of downlink and uplink data sub-frames.

2. Introduction

Presently, advanced wireless data systems are using a packet switching type concept which uses shared channels to maximize the system throughput. Unfortunately, packet switching has problems. For example, too many packets can lead to congestion of a packet switched network and packets that cannot be stored or delivered might be discarded by a packet switching exchange. Also, packets can arrive at different times and in a different order than when they were sent, which is a problem for telephone conversation-type data. In a packet switching environment, a scheduler allocates connections every frame. However, the overhead for allocating fixed connections every frame adds additional complexity.

Contrary to packet switching, for circuit switching, each session is allocated a fixed fraction of the capacity on each link along its path for the entire duration of a session. Circuit switching requires dedicated resources and a fixed path. If the capacity is fully used, calls are blocked, such as in a telephone network. While circuit switching provides advantages, such as fixed delays and guaranteed continuous delivery, it also provides disadvantages, such as circuits that are not used when a session is idle, inefficiency for bursty traffic, and a fixed rate data stream that is inefficient for supporting variable data rates. While packet switching provides advantages, such as efficiency for bursty data and ease of providing bandwidth on demand with variable rates, it also provides disadvantages, such as variable delays, difficulty in providing Quality of Service (QoS) assurances, and the arrival of packets out of order.

For example, in the latest version of the 802.16e specification, the downlink and uplink data frame formats are based solely on the packet switching concept which uses shared channels for all users in order to maximize the throughput for the entire system. This packet switching concept works well for most data applications that are bursty and require on demand bandwidth with variable data rates. However, Voice over Internet Protocol (VoIP) and video streaming operate most efficiently when fixed delays and guaranteed delivery are employed and there are certain drawbacks when using packet switching, such as received data packets arriving out of order and at variable times. These drawbacks may degrade the performance of VoIP and video streaming when only packet switching is available.

Thus, there is a need for more flexibility in the definition of the uplink and downlink frame formats by allowing a virtual circuit area to be defined in a burst area of downlink and uplink data sub-frames in order to allow certain applications that require higher QoS to operate better.

### SUMMARY

A method and apparatus for a virtual circuit data area within a packet data frame is disclosed that can provide flexibility in the definition of uplink and downlink frame formats by allowing a virtual circuit area to be defined in a burst area of downlink and uplink data sub-frames in order to allow certain applications that require higher QoS to operate better. The method may include operating in a multiple connections sharing packet data frame structure with a packet oriented switching wireless access point and a related network for providing data to a wireless communication device engaged in data communications and determining if a pseudo-circuit switched data area within a packet data frame format is optimal for a connection. The method may also include setting up a virtual circuit data area within a packet data frame using a control configuration if a pseudo-circuit switched data area within a packet data frame format is optimal for a connection and sending data in the virtual circuit data area.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary block diagram of a system in accordance with one embodiment;

FIG. 2 illustrates an exemplary block diagram of a device in accordance with one embodiment;

FIG. 3 is an exemplary flowchart illustrating the operation of a device in accordance with one embodiment;

FIG. 4 is an exemplary illustration of a downlink packet data frame and an uplink packet data frame according to one embodiment;

FIG. 5 is an exemplary illustration of information elements with respect to frames and time according to one embodiment; and

FIG. 6 is an exemplary illustration of frames with respect to time according to one embodiment.

### DETAILED DESCRIPTION

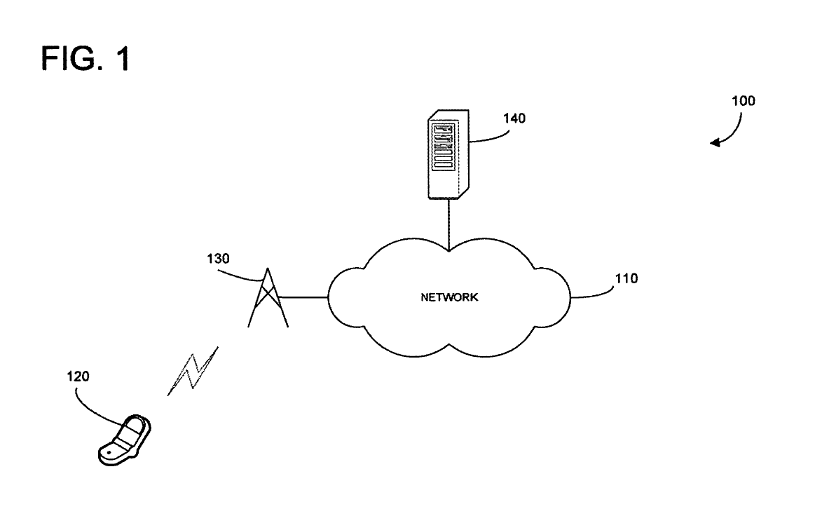

FIG. 1 is an exemplary block diagram of a system 100 according to one embodiment. The system 100 can include a network 110, a terminal 120, an access point 130, and a network controller 140. The terminal 120 may be a wireless communication device, such as a wireless telephone, a cellular telephone, a personal digital assistant, a pager, a personal computer, a selective call receiver, or any other device that is capable of sending and receiving communication signals on a network including a wireless network.

In an exemplary embodiment, the network controller 140 is connected to the network 110. The controller 140 may be located at the access point 130, at a radio network controller (not shown), or anywhere else on the network 110. The access point 130 may be a cellular network base station, a wireless local area network access point, a nodeB base station, or any other access point for providing wireless access to a network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, an Orthogonal Frequency Division Multiple Access (OFDMA) network, a satellite communications network, a Wireless Local Area Network (WLAN) such as an 802.11 or an 802.16 network, and other like communications systems. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. The system 100 can provide a multiple connections sharing packet data frame structure with a packet oriented switching wireless access point 130 and a related network 110 for providing data to a wireless communication device engaged in data communications.

In operation, the terminal 120 can operate in the system 100. The system 100 can determine if a virtual circuit switched data area within a packet data frame format is optimal for a connection. If a virtual circuit switched data area within a packet data frame format is optimal for a connection, the system 100 can then set up a virtual circuit data area of a fixed size at a fixed location within a packet data frame for multiple frames using an interval usage code that indicates duration, size, and location of the virtual circuit data area. The virtual circuit data area can include a fixed length block area within uplink and downlink burst areas of data sub-frames to carry fixed length data packets for a fixed duration of time intervals. The interval usage code can include a flag field that indicates the interval usage code is defining a virtual circuit data area and the interval usage code can include a period field that indicates a number of frames during which the virtual circuit data area is active. The system 100 can then send data in the virtual circuit data area. Data from the virtual circuit data area can be rescheduled into a regular packet data area during overflow conditions of the virtual circuit data area.

According to a related embodiment, a virtual circuit area can use a semi-fixed length block area within uplink and downlink burst areas of data sub-frames. This virtual circuit area can be designed to carry fixed-length data packets for a fixed duration of time intervals and can emulate a circuit switch. These fixed-length data packets can be used by applications such as Voice over Internet Protocol (VoIP), video streaming, and other applications that can require higher Quality of Service (QoS) than could be achieved by sending data packets using a pure packet switched network. As a result, a savings in mapping overhead can occur, as the control of circuit switching can be less complicated than packet switching.

The burst areas within the virtual circuit area can be allocated and controlled by using an enhanced Extended Downlink Interval Usage Code (DIUC) and an Extended Uplink Interval Usage Code (UIUC). These usage codes can control when and how often the virtual circuit burst areas can be used. Also, since within this virtual circuit area the burst data areas can be fixed for a set duration, the Extended DIUC or Extended UIUC may be present only in the MAP area of the frame when this burst area is first allocated. This technique can save MAP space overhead during virtual circuit area use. Any Hybrid Automatic Repeat Request (HARQ) retransmissions can occur outside of the virtual circuit area, such as in a packet switching region of the subframe for uplink and downlink.

Any overflows from the virtual circuit area can be placed back into a regular packet switching area such as a Partial Usage of Subchannels (PUSC) area. The virtual circuit area can also use an inactivity timer for a specific burst area for when the terminal 120 stops utilizing an already assigned burst area for a specific number of frames. Once this inactivity timer has expired, this area can either be released or multiplexed to other terminals. Alternatively, a bandwidth request mechanism, such as a zero Bandwidth Request (BR) via Channel Quality Indicator (CQI) channel, can be used for terminating the circuit area when the terminal 120 does not have any data to send.

As an example, if a VoIP terminal 120 is currently not meeting the needed QoS requirements in order to effectively use a VoIP application, the terminal 120 can indirectly request use of the virtual circuit area for its session by specifying very strict QoS requirements for its application. During this time, a burst area can be allocated in the virtual circuit area to handle this VoIP application. This burst area can be set up in the uplink and downlink areas by using the Extended DIUC/UIUC each time a virtual circuit area is needed in the subframe. Since the virtual circuit area is semi-static over a number of subframes, the Extended DIUC/UIUC can be instantiated only at the first occurrence of this virtual circuit area thus valuable MAP overhead area can be saved for subsequent sub-frames in this sequence of sub-frames.

A virtual circuit area information element (IE) can be used to set up the virtual circuit area. The virtual circuit area information element can include a DIUC field, a length field, a Connection Identification (CID), an Orthogonal Frequency Division Multiple Access (OFDMA) symbol offset field, a subchannel offset field, a number of OFDMA symbols field, a number of subchannels field, a virtual circuit duration field, an area location field, a Adaptive Modulation and Coding (AMC) type field, and a repetition coding indication field. The virtual circuit duration field can denote the number of frames that the virtual circuit area in the packet data frame is set up for. The area location field can denote whether PUSC or AMC is used. According to another related embodiment, an existing information element can be modified to set up the virtual circuit area. The modified information element can include a virtual circuit flag that denotes whether the information element is for a packet switching area or a virtual circuit area. The modified information element can also include a virtual circuit duration field that denotes the number of frames that the virtual circuit area in the packet data frame is set up for.

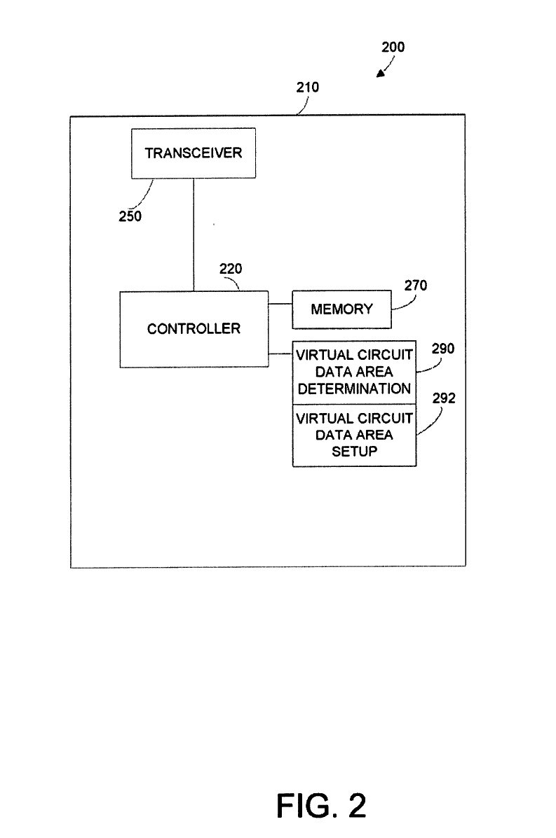

FIG. 2 is an exemplary block diagram of a device 200 according to one embodiment. The device 200 can be located at the controller 140 or the terminal 120. Alternately, different portions of the device 200 may be located at the controller 140 or the terminal 120. The device 200 can include a housing 210, a controller 220 coupled to the housing 210, a transceiver 250 coupled to the housing 210, and a memory 270 coupled to the housing 210. The device 200 can also include a virtual circuit data area determination module 290 and a virtual circuit data area setup module 292. The virtual circuit data area determination module 290 and the virtual circuit data area setup module 292 can be coupled to the controller 220, can reside within the controller 220, can reside within the memory 270, can be autonomous modules, can be software, can be hardware, or can be in any other format useful for a module on a device 200.

The transceiver 250 may be a wireless transceiver, a wired network connection, or any other connection for sending and receiving data to and from a network. The memory 270 may include a random access memory, a read only memory, an optical memory, or any other memory that can be coupled to a device.

In operation, the controller 220 can control the operations of the device 200. The transceiver 250 can send and receive signals in a multiple connections sharing packet data frame structure with a packet oriented switching wireless access point and a related network for providing data to a wireless communication device engaged in data communications. The virtual circuit data area determination module 290 can determine if a virtual circuit switched data area within a packet data frame format is optimal for a connection. The virtual circuit data area set up module 292 can set up a virtual circuit data area within a packet data frame using a control configuration if a virtual circuit switched data area within a packet data frame format is optimal for a connection. The transceiver 250 can send data in the virtual circuit data area.

When a virtual circuit switched data area within a packet data frame format is optimal for a connection, the virtual circuit data area set up module 292 can set up a virtual circuit data area of a fixed size at a fixed location within a packet data frame for multiple frames using a control configuration. The control configuration can be an information element that indicates duration of the virtual circuit data area over a plurality of frames. The information element can include an indicator that the information element is defining a virtual circuit data area and can include a period field that indicates a number of frames during which the virtual circuit data area is active. The virtual circuit data area can include a fixed length block area within uplink and downlink burst areas of data sub-frames to carry fixed length data packets for a fixed duration of time intervals.

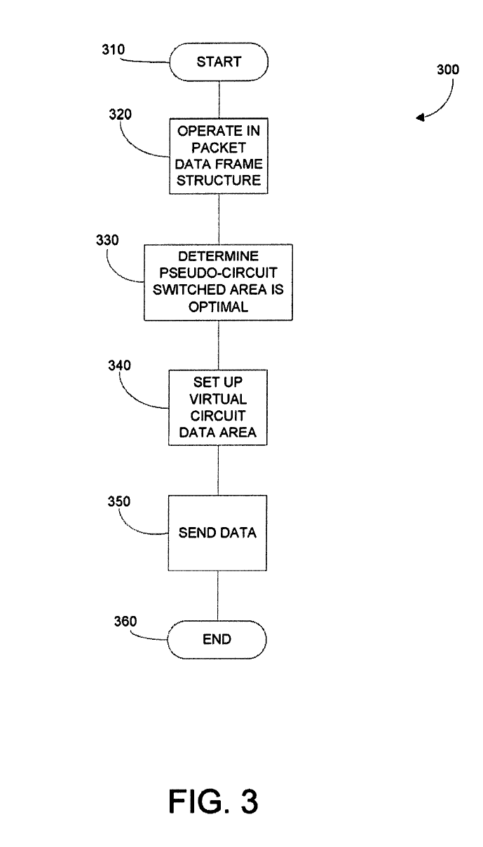

FIG. 3 is an exemplary flowchart 300 illustrating operation of the device 200 according to another embodiment. In step 310, the flowchart begins. In step 320, the device 200 can operate in a multiple connections sharing packet data frame structure with a packet oriented switching wireless access point and a related network for providing data to a wireless communication device engaged in data communications. In step 330, the device 200 can determine if a pseudo-circuit switched data area within a packet data frame format is optimal for a connection. The device 200 can determine if a pseudo-circuit switched data area within a packet data frame format is optimal for a connection based on quality of service requirements and/or an amount of data in a buffer.

In step 340, the device 200 can set up a virtual circuit data area within a packet data frame using a control configuration if a pseudo-circuit switched data area within a packet data frame format is optimal for a connection. The control configuration can be an information element that indicates a duration of the virtual circuit data area. The information element can include an indicator that indicates the information element is defining a virtual circuit data area and the information element can include a period field that indicates a number of frames during which the virtual circuit data area is active. The device 200 can set up a virtual circuit data area within a packet data frame by setting up a virtual circuit data area of a fixed size at a fixed location within a packet data frame for multiple frames using a control configuration. The device 200 can set up a virtual circuit data area by setting up a virtual circuit data area within a packet data frame for downlink and uplink frames using a control configuration in an existing downlink and uplink map.

In step 350, the device 200 can send data in the virtual circuit data area. The device 200 can send data in the virtual circuit data area without sending corresponding map information when the virtual circuit area maintains a static format from one frame to another frame. The virtual circuit data area can be a fixed length block area within uplink and downlink burst areas of data sub-frames to carry fixed length data packets for a fixed duration of time intervals. The device 200 can change the QoS requirement for a connection based on different parameters during a period of the connection. The device 200 can also multiplex multiple connections with different frames in the same virtual circuit data area. The device 200 can additionally redirect certain data areas within the virtual circuit area from an original to different connections if at least one of the original connections does not have data to send. The device 200 can further reschedule data from the virtual circuit data area into a regular packet data area during overflow conditions of the virtual circuit data area. The device 200 can perform setting up a connection, changing a connection, re-directing a connection and/or terminating a connection using separate control messages within a regular packet data area. In step 360, the flowchart 300 ends.

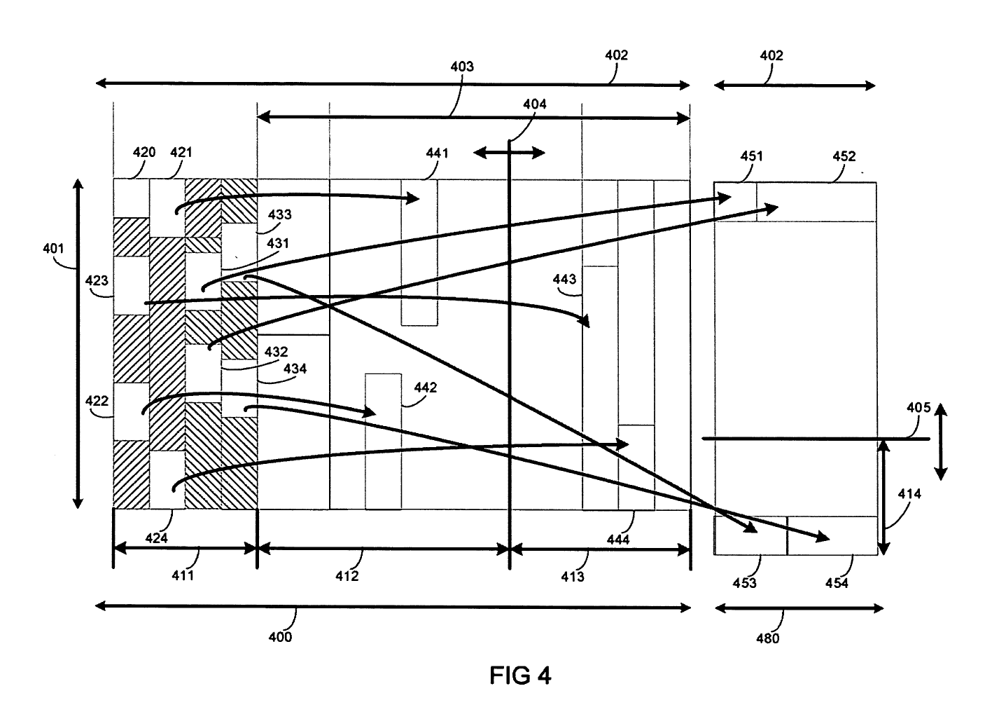

FIG. 4 is an exemplary illustration of a downlink packet data frame 400 and an uplink packet data frame 480 according to one embodiment. The downlink packet frame 400 can carry data from the access point 130 to the terminal 120 and the uplink frame 480 can carry data from the terminal 120 to the access point 130. The downlink packet frame 400 can be spread across a plurality of subchannels 401 with respect to frequency and spread across a plurality of symbols 402, such as OFDMA symbols, or other symbols depending on the wireless system being used, with respect to time. A portion of the symbols 402 may be available for HARQ or non-HARQ transmissions 403. The downlink packet data frame 400 can include a map area 411, a packet area, such as a regular Partial Usage of Subchannels PUSC area 412, and a virtual circuit area 413. The regular PUSC area 412 and the virtual circuit area 413 may be divided by a movable boundary 404 with respect to the symbols that may change depending on resource availability or allocation. The movable boundary 404 may also divide the downlink data area with respect to the subchannels 401 depending on the technology used or the desired division. The map area 411 can inform the terminal 120 of the layout of the rest of the downlink frame 400 and the uplink frame 480. The uplink frame 480 can include a virtual circuit area 414 that can be defined by a movable boundary 405 with respect to the subchannels that may change depending on resource availability or allocation. The movable boundary 405 may also divide the uplink data area with respect to the symbols 402 depending on the technology used or the desired division. The regular PUSC area 412 can include variable lengths of data sent to the terminal 120. The virtual circuit area 413 can include data sent to the terminal 120 in a virtual circuit switched manner. If retransmission is necessary for data sent in the virtual circuit area 413, the data can be retransmitted in the regular PUSC area 412. Also, if additional data needs to be sent over a connection using the virtual circuit area 413, the data can be sent in the regular PUSC area 412.

The map area 411 can include a Frame Control Header (FCH) 420 that can be the first burst appearing in the downlink portion of a frame. The FCH 420 can contain a Downlink map (DL-MAP) message, one Uplink map (UL-MAP) message for each associated uplink channel, and optionally, a Downlink Channel Descriptor (DCD) message and an Uplink Channel Descriptor (UCD) message for each associated uplink channel. The map area 411 can also include DIUCs 421 and 422 that can be interval usage codes specific to downlink 441 and 442, respectively. Such an interval usage code can identify a particular burst profile 441 and 442 in the regular PUSC area 412 that can be used by a downlink transmission interval. A burst profile can be a set of parameters that describe the uplink or downlink transmission properties associated with an interval usage code. Each profile can contain parameters such as modulation type, forward error correction (FEC) type, preamble length, and guard times. The map area 411 can additionally include extended DIUCs 423 and 424 that can identify bursts 443 and 444, respectively, in the virtual circuit area 413. The map area 411 can further include Uplink Interval Usage Codes (UIUCs) 431 and 432 that can identify bursts 451 and 452, respectively, specific to an uplink burst in the uplink frame 480. The map area 411 can also include extended UIUCs 433 and 434 that can identify burst profiles 453 and 454, respectively, specific to uplink bursts in the virtual circuit area 414 of the uplink frame 480.

Connection QoS properties can change which can affect whether a virtual circuit area 413 is needed. Basic management messages can be used within the PUSC area 412 to change the QoS property. Also, data lost in the virtual circuit area 413 can be retransmitted in the PUSC area 412. A regular information element can be used in the map area 411 to define the retransmission.

When data is not received on a burst in the virtual circuit area 413 for a selected period, the burst area can expire, and the bandwidth can be used for other users. Frames can be multiplexed with multiple connections at the same frame location. Data can be moved from the virtual circuit area 413 to the packet area 412 during overflow conditions of virtual circuit area 413. Also, applications can be guaranteed a target data rate for downlink and uplink connections. Furthermore, map overhead can be reduced using circuit-type connections, such as the virtual circuit area 413. Additionally, control signaling and data payload can be separated in different areas, such as using control signaling in the packet area 412 using Basic/Primary/Secondary CIDs, while using data payload signaling in the virtual circuit area 413. The virtual circuit data area boundary 404 can be a moving boundary defined with individual control and can divide the packet area 412 along either the symbol 402 or the subchannel 401 axis.

Candidates for the virtual circuit area can be dynamically added and removed. Eligible terminals can get added by requesting a QoS service with a fixed amount of bandwidth. Such services can include VoIP, video streaming, and other services that benefit from a fixed bandwidth. Eligible terminals may need to meet the guaranteed bandwidth as credited. If more bandwidth is required, the access point 130 may schedule the excess data into the packet data area 412. If a terminal 120 violates the amount of bandwidth allocated in the virtual circuit area a selected number of times before the expiration of the allocation, the guaranteed bandwidth can be revoked and offered to other terminals. Furthermore, if the requested bandwidth is not used as expected by the original request for a selected number of times, the access point 130 can revoke the virtual circuit area bandwidth even before the allocation expires, and give the bandwidth to other terminals.

Thus, the present disclosure can provide for a virtual circuit data area 413 within a packet data area 412. An extended DIUC/UIUC or other message can be used to indicate where and how often the area for that connection exists. A soft area with a moving boundary 404 defined by the individual controls can make the scheme flexible.

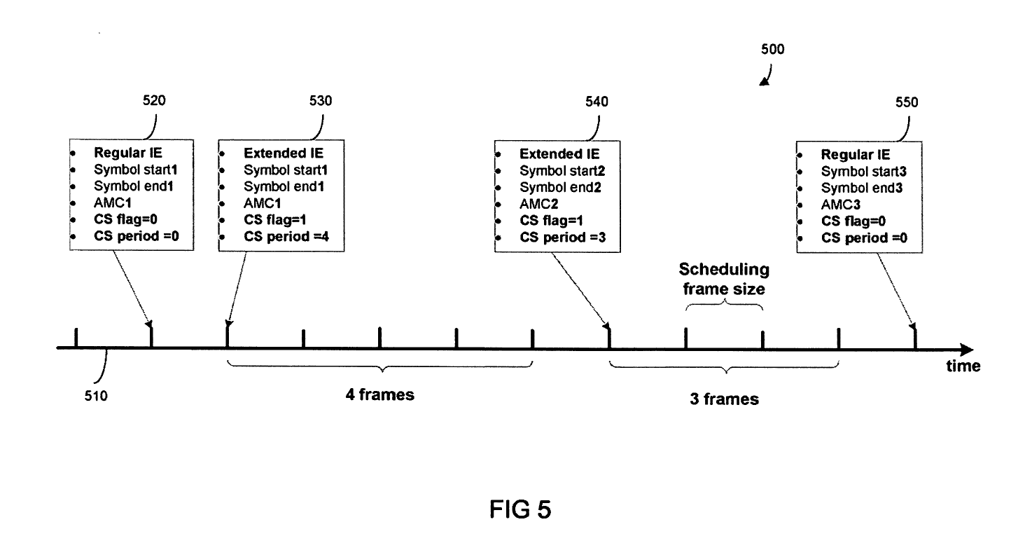

FIG. 5 is an exemplary illustration 500 of information elements with respect to frames and time 510. A regular information element 520 can be used for packet data. The regular information element 520 can designate a starting symbol location and an ending symbol location along with the AMC used for the corresponding connection. The regular information element 520 can indicate that it is a regular information element by setting an indicator, such as a Circuit Switched (CS) flag and/or a CS period to zero. An extended information element 530 can be used to set a virtual circuit switched data area for a corresponding connection. The extended information element 530 can designate a starting symbol location and an ending symbol location along with the AMC for the connection. The extended information element 530 can indicate that it is an extended information element by setting an indicator, such as a CS flag to one. The extended information element 530 can also indicate the number of frames for which the virtual circuit switched connection is active using a CS period indicator, which, in this case, can be four. Additional extended information elements 540 and regular information elements 550 can be used for later frames. The data area for a particular connection can be fixed until the connection QoS property or the channel has changed. When the terminal 120 is using VoIP, it can use silence suppression when there is no audio to send. Accordingly, the terminal 120 does not have data to send and the connection allocated to the terminal 120 will not be used. Thus, the virtual circuit area can be disabled for the terminal 120. Bandwidth requests can be piggybacked for the virtual circuit areas when a silence suppression period is needed. For example, a Channel Quality Indicator (CQI) can be sent on a dedicated control channel from the terminal 120 to the access point 130 to indicate the virtual circuit area is free due to silence suppression.

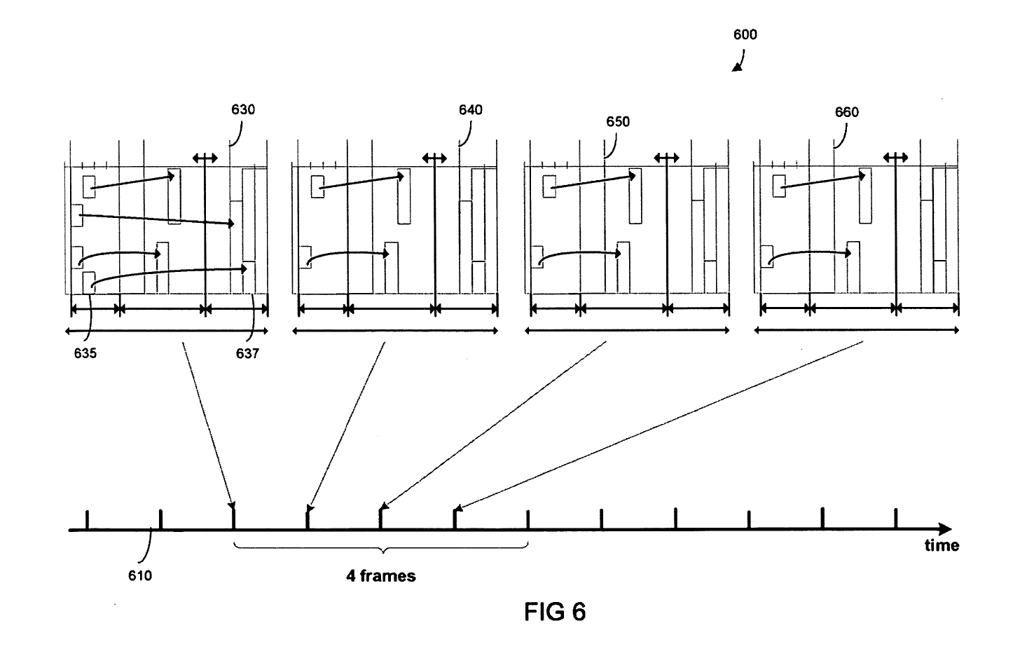

FIG. 6 is an exemplary illustration 600 of frames 630, 640, 650, and 660 with respect to time 610 according to one embodiment. An information element 635 can be included in a frame 630, such as a downlink frame, to designate a section 637 of a virtual circuit data area for a connection. The virtual circuit data area section 637 can be set for a period of a designated number of frames, which in this example can be four frames. Then, for subsequent frames 640, 650, and 660, a corresponding information element does not need to be sent because the virtual circuit data area section 637 is already established for those frames. The uplink frames can be multiplexed among different connections during silence suppression periods. Thus, because the mapping area can be reduced for the downlink, additional bandwidth can become available for both the downlink and the uplink frames.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A method comprising:
operating in a multiple connections sharing packet data frame structure with a packet oriented switching wireless access point and a related network for providing data to a wireless communication device engaged in data communications;
determining if a pseudo-circuit switched data area within a packet data frame format is optimal for a connection;
setting up a virtual circuit data area within a packet data frame using a control configuration if a pseudo-circuit switched data area within a packet data frame format is optimal for a connection; and
sending data in the virtual circuit data area.

2. The method according to claim 1, wherein setting up a virtual circuit data area within a packet data frame comprises setting up a virtual circuit data area of a fixed size at a fixed location within a packet data frame for multiple frames using a control configuration if a pseudo-circuit switched data area within a packet data frame format is optimal for a connection.

3. The method according to claim 1, wherein the control configuration comprises an information element that indicates a duration of the virtual circuit data area.

4. The method according to claim 3, wherein the information element comprises an indicator that the information element is defining a virtual circuit data area and a period field that indicates a number of frames during which the virtual circuit data area is active.

5. The method according to claim 1, wherein determining comprises determining if a pseudo-circuit switched data area within a packet data frame format is optimal for a connection based on at least one of quality of service requirements and an amount of data in a buffer.

6. The method according to claim 1, wherein setting up comprises setting up a virtual circuit data area within a packet data frame for downlink and uplink frames using a control configuration in an existing downlink and uplink map.

7. The method according to claim 1, wherein sending data comprises sending data in the virtual circuit data area without sending corresponding map information when the virtual circuit area maintains a static format from one frame to another frame.

8. The method according to claim 1, wherein the virtual circuit data area comprises a fixed length block area within uplink and downlink burst areas of data sub-frames to carry fixed length data packets for a fixed duration of time intervals.

9. The method according to claim 1, further comprising changing the quality of service requirement for a connection based on different parameters during a period of the connection.

10. The method according to claim 1, further comprising multiplexing multiple connections with different frames in the same virtual circuit data area.

11. The method according to claim 1, further comprising redirecting certain data areas within the virtual circuit area from an original to different connections if the original connection does not have data to send.

12. The method according to claim 1, further comprising rescheduling data from the virtual circuit data area into a regular packet data area during overflow conditions of the virtual circuit data area.

13. The method according to claim 1, further comprising performing at least one of setting up a connection, changing a connection, re-directing a connection and terminating a connection, using separate control messages within a regular packet data area.

14. An apparatus comprising:
a transceiver configured to send and receive signals in a multiple connections sharing packet data frame structure with a packet oriented switching wireless access point and a related network for providing data to a wireless communication device engaged in data communications;
a controller coupled to the transceiver, the controller configured to control the operations of the apparatus;
a virtual circuit data area determination module configured to determine if a virtual circuit switched data area within a packet data frame format is optimal for a connection; and
a virtual circuit data area set up module configured to set up a virtual circuit data area within a packet data frame using a control configuration if a virtual circuit switched data area within a packet data frame format is optimal for a connection,
wherein the transceiver is configured to send data in the virtual circuit data area.

15. The apparatus according to claim 14, wherein the virtual circuit data area set up module is configured to set up a virtual circuit data area within a packet data frame by setting up a virtual circuit data area of a fixed size at a fixed location within a packet data frame for multiple frames using a control configuration if a virtual circuit switched data area within a packet data frame format is optimal for a connection.

16. The apparatus according to claim 14, wherein the control configuration comprises an information element that indicates duration of the virtual circuit data area over a plurality of frames.

17. The apparatus according to claim 14, wherein the information element comprises an indicator that the information element is defining a virtual circuit data area and a period field that indicates a number of frames during which the virtual circuit data area is active.

18. The apparatus according to claim 14, wherein the virtual circuit data area comprises a fixed length block area within uplink and downlink burst areas of data sub-frames to carry fixed length data packets for a fixed duration of time intervals.

19. A method comprising:
operating in a multiple connections sharing packet data frame structure with a packet oriented switching wireless access point and a related network for providing data to a wireless communication device engaged in data communications;
determining if a virtual circuit switched data area within a packet data frame format is optimal for a connection;
setting up, if a virtual circuit switched data area within a packet data frame format is optimal for a connection, a virtual circuit data area of a fixed size at a fixed location within a packet data frame for multiple frames using an interval usage code that indicates duration, size, and location of the virtual circuit data area,
wherein the virtual circuit data area comprises a fixed length block area within uplink and downlink burst areas of data sub-frames to carry fixed length data packets for a fixed duration of time intervals, and
wherein the interval usage code comprises a flag field that indicates the interval usage code is defining a virtual circuit data area and a period field that indicates a number of frames during which the virtual circuit data area is active; and
sending data in the virtual circuit data area.

20. The method according to claim 19, further comprising rescheduling data from the virtual circuit data area into a regular packet data area during overflow conditions of the virtual circuit data area.
